(19) United States
(12) Patent Application Publication
(10) Pub. No.: US 2022/0247195 A1
(43) Pub. Date: Aug. 4, 2022

(54) Suncord Power Extension

(71) Applicant: Sahriar Rahman, Garden Grove, CA (US)

(72) Inventor: Sahriar Rahman, Garden Grove, CA (US)

(21) Appl. No.: 17/163,502

(22) Filed: Jan. 31, 2021

(51) Int. Cl. H02J 7/00; G05B 15/02; H02J 7/35; H02S 10/10

(52) U.S. Cl. CPC H02J 7/0063; G05B 15/02; H02S 10/10; H02J 7/35; H02J 7/0048

(57) ABSTRACT

A system and method for providing a solar powered power source limiting power consumption of attached devices is disclosed. The system includes one or more power cells for providing electrical power to the attached devices, a rechargeable battery, and a controller. The controller includes a voltage regulator-charger for connecting the rechargeable battery and the one or more power cells to the attached devices, a plurality of device power consumption regulators for controlling outgoing electrical power provided by the controller to each of the attached devices, a memory having instructions stored thereon, and a processor configured to execute the instructions on the memory to cause the controller to detect a battery charge level in the rechargeable battery, determine power output currently generated by the one or more power cells, determine whether total power consumption of the attached devices is greater than an available power limit; and when the total power consumption of the attached devices is greater than the available power limit, perform the following steps until the total power consumption of the attached devices is greater than the available power limit determine a lowest priority attached device currently active, and deactivate lowest priority attached device currently active. The available power limit is defined to permit any active attached device to operate for a user specified time period at the current power consumption at which time the rechargeable battery will be empty.

### TECHNICAL FIELD

This application relates in general to a system and method for providing solar powered accessories, and more specifically, to a system and method for providing a solar powered energy source limiting the power consumption of attached devices.

### BACKGROUND

A solar powered extension cord may provide solar energy in-home or outside. It can be used as a world-wide application, whereas people may not have access to electricity in certain countries or regions, but can use the solar powered extension cord to power small devices i.e. tv, phone, radio, small heater, and hot plate. A secondary model has a digital interface which allows the absorbed solar energy to be delegated in certain wattages based on the needed output of set devices. Such a system enables solar energy to be more accessible for everyday usage.

Therefore, a need exists for providing a solar powered energy source limiting power consumption of attached devices. The system and method of the present invention attempt to address the deficiencies and limitations of existing solutions according to the principles and example embodiments disclosed herein.

### SUMMARY

In accordance with the present invention, the above and other problems are solved by providing a system and method for a solar powered energy source limiting power consumption of attached devices according to the principles and example embodiments disclosed herein.

In one embodiment, the present invention is a system for providing a solar powered energy source limiting power consumption of attached devices. The system includes one or more power cells for providing electrical power to the attached devices, a rechargeable battery, and a controller. The controller includes a voltage regulator-charger for connecting the rechargeable battery and the one or more power cells to the attached devices, a plurality of device power consumption regulators for controlling outgoing electrical power provided by the controller to each of the attached devices, a memory having instructions stored thereon, and a processor configured to execute the instructions on the memory to cause the controller to detect a battery charge level in the rechargeable battery, determine power output currently generated by the one or more power cells, determine whether total power consumption of the attached devices is greater than an available power limit; and when the total power consumption of the attached devices is greater than the available power limit, perform the following steps until the total power consumption of the attached devices is greater than the available power limit determine a lowest priority attached device currently active, and deactivate lowest priority attached device currently active. The available power limit is defined to permit any active attached device to operate for a user specified time period at the current power consumption at which time the rechargeable battery will be empty.

In another embodiment, the present invention is a method for providing a solar powered energy source limiting power consumption of attached devices. The method detects a battery charge level in the rechargeable battery, determines power output currently generated by the one or more power cells, determines whether total power consumption of the attached devices is greater than an available power limit; and when the total power consumption of the attached devices is greater than the available power limit, performs the following steps until the total power consumption of the attached devices is greater than the available power limit: determine a lowest priority attached device currently active, and deactivate lowest priority attached device currently active. The available power limit is defined to permit any active attached device to operate for a user specified time period at the current power consumption at which time the rechargeable battery will be empty.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system that provides a solar powered energy source limiting power consumption of all devices according to the present invention.

FIG. 2 illustrates an example embodiment of a set of electronic components for providing a solar powered energy source limiting power consumption of all devices according to the present invention.

FIG. 3 illustrates a flowchart corresponding to a method performed by software within a system for providing a solar powered energy source limiting power consumption of attached devices according to the present invention.

FIG. 4 illustrates a generalized schematic of a programmable processing system utilized as the various computing components described herein used to implement an embodiment of the present invention.

### DETAILED DESCRIPTION

This application relates in general to a system and method for providing solar powered accessories, and more specifically, to a system and method for providing a solar powered energy source limiting the power consumption of attached devices according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a media player, set-top box, smartphone, tablet, and/or web browser on any computing device.

The terms “customer,” and “user” refer to an entity, e.g. a human, using a solar powered energy source limiting power consumption of attached devices including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

The term “invention” or “present invention” refers to the invention being applied for via the patent application with the title “A Solar Powered Energy Source.” Invention may be used interchangeably with power source.

The terms “communicate”, or “communication” refer to any component(s) connecting with any other component(s) in any combination for the purpose of the connected components to communicate and/or transfer data to and from any components and/or control any settings.

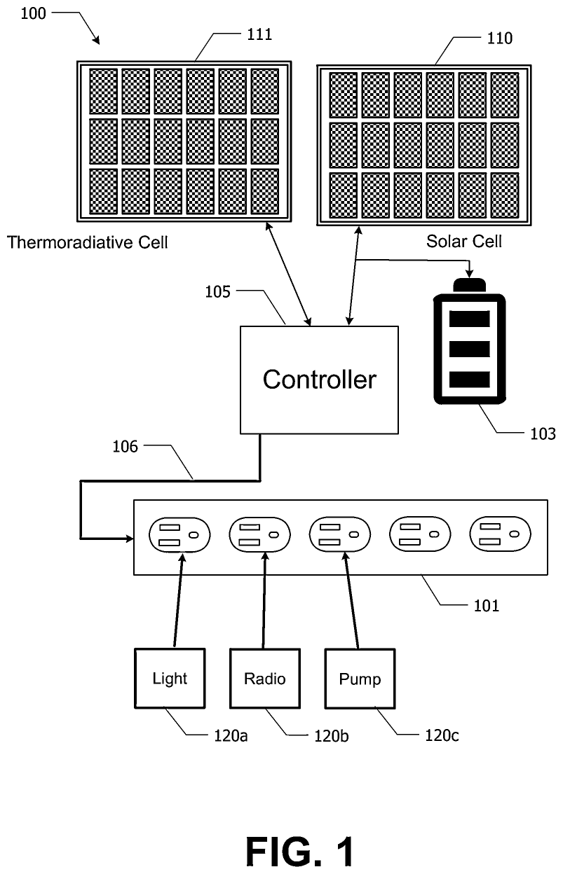

In general, the present disclosure relates to a system and method for providing solar powered accessories. To better understand the present invention, FIG. 1 illustrates an example embodiment of a system that provides a solar powered energy source limiting power consumption of attached devices according to the present invention. A sun powered extension cord system 100 includes a solar power cell array 110 and a thermo-radiative power cell 111 coupled to a controller 105 and a battery 103. The controller 105 enables power from either the solar power cell array 110 or the thermo-radiative power cell 111 to be used by one or more attached devices 120a-c as well as used to charge an enclosed battery 103 depending upon whether the particular power cell is active.

The solar cell 110 receives light energy and converts into electrical charge within the solar cells 110 that may be transmitted by the controller 101 to the attached devices 120 a-c and the battery 103. In contrast the thermo-radiative power cell 111 operates during nighttime hours to generate charge by radiating thermal energy towards the colder sky and out to space that may be transmitted by the controller 101 to the attached devices 120a-c and the battery 103. In many situations, the controller 101 may be able to transmit charge generated by one of the two power cell arrays 110-111 to power the attached devices 120a-c and the battery 103. Additional details regarding the power cell arrays 110-111 may be found within in, C.; Wang, B.; Teo, K. H.; and Zhang, Z, “Performance comparison between photovoltaic and thermoradiative devices,” MITSUBISHI ELECTRIC RESEARCH LABORATORIES, TR2017-211, December 2017. https://www.merl.com/publications/docs/TR2017-211.pdf. The details of this paper are incorporated herein by reference in its entirety.

The battery 103 also may be used to provide electrical charge to the attached devices 120a-c when a power cell arrays 110-111 are not able to provide electrical power, such as during the nighttime or during cloudy days. The battery 103 may also be useful in supplementing available power needed to power the attached devices 120a-c when the solar power cell array 110 is not enough to power all of the devices at one time.

The controller 105 provides electrical power to one or more electrical outlets within a power strip 101 used to plug in the attached devices 120a-c. The power strip 101 is shown providing standard electrical receptacles that provide AC power to devices. An extension cord 106 may connect the controller 105 to the power strip 101 in order to permit the power to be provided to the attached devices 102a-c at different locations that are not necessarily adjacent to a solar power cell array 110. One of ordinary skill may recognize that other electrical power such as DC voltage may also be provided to power the attached devices 120a-c.

Additionally, the connectors of the power strip 101 may provide other types of connectors such as a USB-A/USB-C connector typically used to power small electrical devices as well as computing devices of many types. The controller 105 may be used to control which of the multiple connectors, and thus attached devices 120a-c, receives electrical power. As such, the controller 105 may dynamically limit the power consumption of the attached devices 120a-c based upon the available power from the solar power cell array 110 and the battery 103.

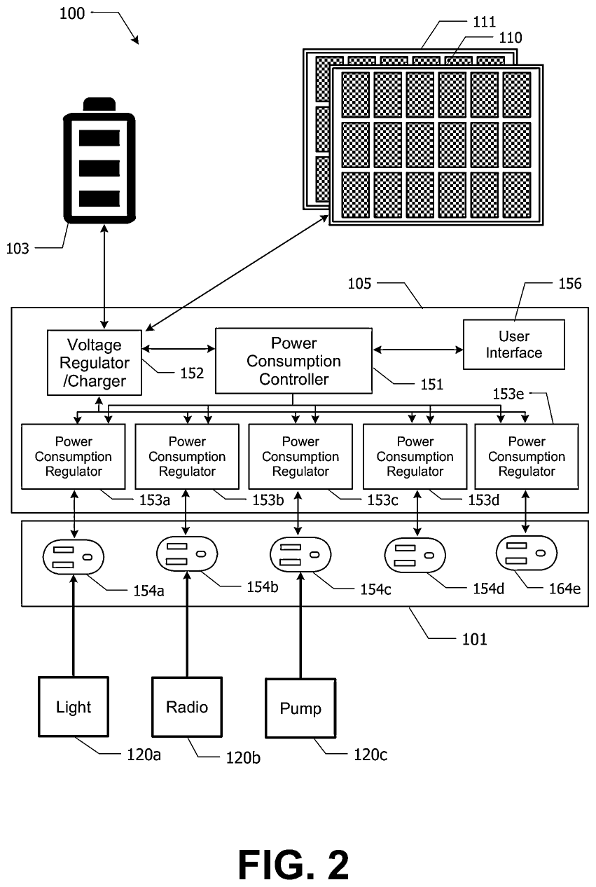

FIG. 2 illustrates an example embodiment of a set of electronic components for providing a solar powered energy source limiting power consumption of attached devices according to the present invention. Again, in this embodiment, a solar power cell array 110 is coupled to a controller 105 and a battery 103. A set of attached devices 120a-c is receiving electrical power from the controller 105.

The controller 105 comprises a power consumption controller 151, a voltage regulator/charger 151, a plurality of device power consumption regulators 153a-e, and a user interface 156. The power consumption controller 151 determines which of the attached devices is to receive electrical power from the solar power array 110 and battery 103 based upon its configuration. The power consumption controller 151 uses the available power from the solar power array 110 and battery 103, indicates the state of charge and health of the battery 103, monitors power consumption of each of the attached devices 120 a-c, and contains any instructions and configuration set by a user to determine which of the attached devices 120a-c is to be provided power. The power consumption controller 151 may disable power from one attached device to preserve available power resources to maintain power to other attached devices at times when the solar power array 110 and battery 103 are unable to provide power to all of the enabled attached devices 120a-c.

The voltage regulator/charger 151 receives input voltage from the solar power cell array 110 and transforms the voltage as needed to charge the battery 103. The voltage regulator/charger 151 monitors the charge level of the battery 103 to perform the recharging operation as needed. The voltage regulator/charger 151 also monitors the charge level of the battery 103 when attached devices 120a-c are drawing power to maintain the useful capacity of the battery 103. The voltage regulator/charger 151 provides information regarding the charge level of the battery 103, the rate of charge and/or consumption of stored electrical charge, and battery health to the power consumption controller 151 for use in determining which of the attached devices 120a-c is to be enabled under current conditions.

Each of the plurality of device power consumption regulators 153a-e controls outgoing electrical power provided by the controller 105 to each of the corresponding attached devices 120a-c. The device power consumption regulators 153a-e enables its power connection from the solar power array 110 and battery 103 to its corresponding attached device 102a-c based upon commands received from the power consumption controller 151. The device power consumption regulators 153a-e also monitor the power consumption of its corresponding attached device 102a-c and provides the consumption data to the power consumption controller 151 for use as well. The device power consumption regulators 153a-e lastly perform any voltage transformation to provide electrical power in the proper voltage needed by its attached device 102a-c as appropriate.

The user interface 156 provides input and output processing to provide a user with messages and data needed to perform the configuration and operating functions of the power source system 100. This user interface module 156 also accepts commands from the user to instruct the application to perform these tasks. The user interface 156 may be electrically connected to a display and input device (not shown) to provide data to the user as well as accept input commands from the user. The display/input device may be a LED display and keypad attached to the controller 105. The display/input devices may also be external devices such as displays and keyboards. In one possible embodiment, the user interface is part of a wireless communications interface, such as one provided by a Bluetooth™ or Wifi interface, to allow an external computing device to connect to the power consumption controller 150 to receive data and provide commands to configure and operate the power source 100. In such an embodiment, a mobile application running on a smartphone or similar mobile device may be used to communicate with the controller 105 for these functions.

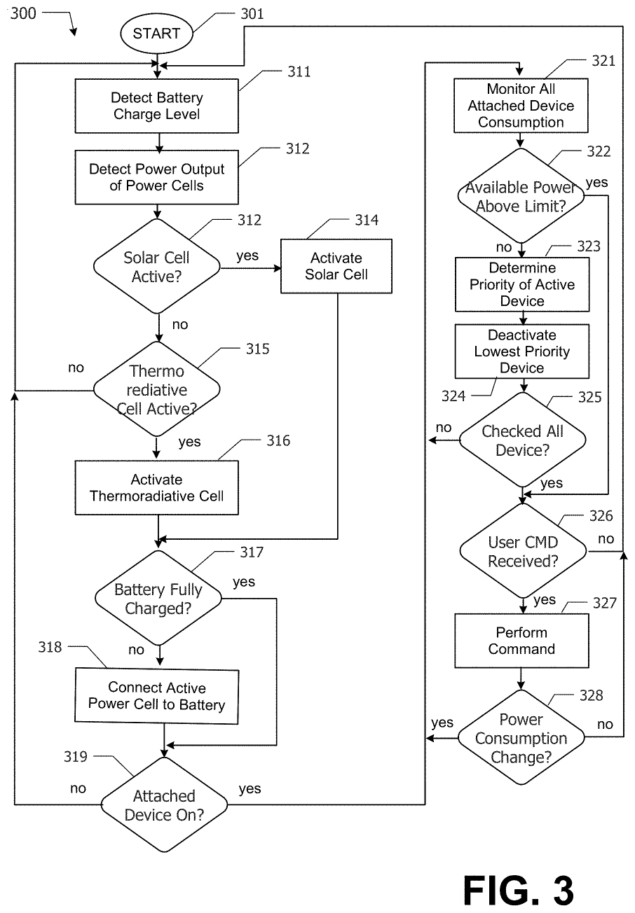

FIG. 3 illustrates a flowchart corresponding to a method performed by software within a system for providing a solar powered energy source limiting power consumption of attached devices according to the present invention. The process 300 begins 301 and the power consumption controller 151 by detecting a charge level in the battery 103 in step 311. In step 312, the power consumption controller 151 detects whether of the power cell arrays 110-111 are active and producing electrical charge. The power consumption controller 151, in test step 313 determines whether the solar cell array 110 is producing electrical charge, and if so a connection between the solar cell array 110 and the power consumption controller 151 is activated in step 314; otherwise the process 300 proceeds directly to test step 315.

The power consumption controller 151, in test step 315 determines whether the thermo-radiative cell array 111 is producing electrical charge, and if so a connection between the thermo-radiative cell array 111 and power consumption controller 151 is activated in step 316; otherwise the process 300 proceeds directly to test step 317.

The power consumption controller 151, in test step 317 determines whether the battery is fully charged, and if not a connection between the power consumption controller 151 and the battery 103 is activated in step 318; otherwise the process 300 proceeds directly to test step 319.

The power consumption controller 151, in test step 319 determines whether the active and consuming electrical charge, and if not, the process returns to step 311 to continue to monitor the battery 103 and the power cell arrays 110-111; otherwise the process 300 proceeds to step 321 to begin measuring an active power consumption level for one of the attached devices 120a-c. Next in test step 322, the power consumption controller 151 determines whether the total power consumption of all of the attached devices 120a-c exceeds a power limit, and if not, power consumption controller 151 determines the identity of a lowest priority active attached device 120a-c in step 323 and disables the power connection to this lowest priority active attached device 120a-c in step 324. The power consumption controller 151, in test step 325 determines whether all of the attached devices 120a-c have been tested, and if not, the process 300 returns to step 321 to continue checking the remaining attached devices.

When test step 325 determines that all of the attached devices 120a-c have been checked, the process 300 proceeds to the user command portion of the process 300 in test step 326. Returning to test step 322, when the power consumption controller 151 determines that the total power consumption of all of the attached devices 120a-c is below the power consumption power limit, the process 300 proceeded directly to the user command portion of the process 300 in otherwise test step 326. The portion of the process 300 between step 321 and test step 325 performs any needed adjustment to the activity, and thus the power consumption of the attached devices 102a-c based upon a user defined priority arrangement.

The power limit determines whether amount of power consumption consumed by the attached devices 120a-c is reducing the charge level of the battery 103 below a stated threshold. A user may set the stated threshold at a charge level that provides an amount of stored charge in the battery 103 to maintain a highest priority device 120a-c for a particular amount of time. The power limit may use any charge being produced by either of the power cell arrays 110-111 to determine whether the charge level within the battery 103 is rising or falling. The charge level in the battery 103 will typically rise when the amount of charge produced by the power cell arrays 110-111 exceeds the total power consumption being consumed by the active attached devices 102a-c. In such a situation, all of the active attached devices 120a-c may be provided power. Any amount of charge available above the amount of total power consumption being consumed by the active attached devices 102a-c may be used to recharge the battery 103. When the charge level of the battery 103 is falling, the battery 103 may be drained of all of its charge if the rate of falling continues. The falling of the level of charge within the battery 103 is the situation in which the power consumption controller 151 may determine to deactivate one or more of the active attached devices 120a-c to extend the time the charge may be available for use by higher priority attached devices.

As noted above, test step 326 causes the power consumption controller 151 to determine whether the user has provided an input command to the controller 105. For example, the input command may be used to define current priority levels for each of the attached devices 120a-c. The input command may also manually activate or disable power to an attached device 120a-c regardless of the level of power consumption or charge remaining in the battery 103. The user command may be used to set a stated threshold for charge within the battery 103 for used in the steps above. Using these commands, a user may define the operation of the controller 105 and the electrical power provided to one or more of the attached devices.

When test step 326 causes the power consumption controller 151 to detect an input command, the power consumption controller 151 performs the input command in step 327 before test step 328 determines whether the input command has caused a change in current power consumption of all of the attached devices. When test step 328 determines that the total power consumption of the controller 105 has changed, the process 300 returns to step 321 to repeat the above steps to determine which of the active attached devices 120a-c are to be enabled based upon the new power consumption level. This return to step 321 permits the power consumption controller 151 to rest all of operating states of the active attached devices 120a-c based upon the change made by the user in the input command.

When test step 328 determines that the input command has not changed the current power consumption of all of the active attached devices 120a-c, the process returns to step 311 to begin the above process to detect the power being generated by the power cell arrays 110-111 and the charge level within the battery 103 before once again determining whether the power consumption is falling and may drain the battery 103. Returning to test step 326, the power consumption controller 151 causes the process 300 to return to step 311 to once again being then above processing cycle when no input command is detected. This process continues until the entire device is deactivated as the battery 103 may be utilizes all of the time by at least one active attached device 102a-c and the battery 103 may be recharges at all times of the day and night by either the solar cell array 110 or the thermo-radiative power cell array 111 depending upon the conditions around the power cell arrays 110-111.

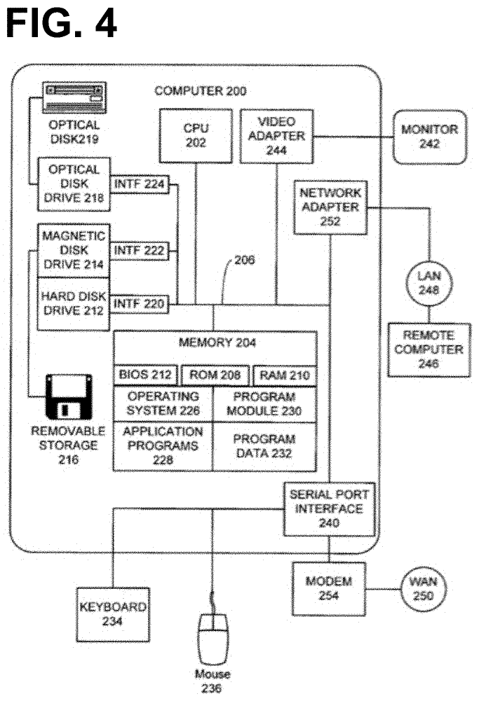

FIG. 4 illustrates a generalized schematic of a programmable processing system utilized as the various computing components described herein used to implement an embodiment of the present invention. The power consumption controller 151 may be implemented as a digital processing system 200 that contains software in the form of executable instructions stored within memory of the controller 105. When the CPU 202 executes these instructions in memory, the power consumption controller 151 performs the functions of the system 100 as described herein.

The CPU 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of the computer system 200. Rather the computer system 200 is provided as an example of one type of computing device that may be adapted to perform the functions of a parking management system, including servers, personal computers, and mobile devices as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing a solar powered energy source limiting power consumption of attached devices, the system comprising:
one or more power cells for providing electrical power to the attached devices;
a rechargeable battery;
a controller, the controller comprises:
a voltage regulator-charger for connecting the rechargeable battery and the one or more power cells to the attached devices;
a plurality of device power consumption regulators for controlling outgoing electrical power provided by the controller to each of the attached devices;
a memory having instructions stored thereon; and
a processor configured to execute the instructions on the memory to cause the electronic controller to:
detect a battery charge level in the rechargeable battery;
determine power output currently generated by the one or more power cells;
determine whether total power consumption of the attached devices is greater than an available power limit; and
when the total power consumption of the attached devices is greater than the available power limit, perform the following steps until the total power consumption of the attached devices is greater than the available power limit:
determine a lowest priority attached device currently active; and
deactivate lowest priority attached device currently active;
wherein the available power limit is defined to permit any active attached device to operate for a user specified time period at the current power consumption at which time the rechargeable battery will be empty.

2. The system according to claim 1, wherein the system further comprises:
a user interface connecting the controller to a user display device and a user input device.

3. The system according to claim 2, wherein the user display device comprises a LED display.

4. The system according to claim 2, wherein the user input device comprises a keypad.

5. The system according to claim 2, wherein the user display device and the user input device comprise a touch screen display.

6. The system according to claim 1, wherein the one or more power cells comprise one or more solar cells.

7. The system according to claim 1, wherein the one or more power cells comprise one or more thermo-radiative power cells.

8. The system according to claim 1, wherein the one or more power cells comprise:
one or more solar cells; and
one or more thermo-radiative power cells.

9. The system according to claim 1, wherein the processor configured to execute additional instructions to further cause the controller to:
when one or more of the power cells are active, activate the power cells to provide electrical power to the voltage-regulator-charger; and
when the rechargeable battery is fully charged disconnect the active one or more power cells from the battery.

10. The system according to claim 2, wherein the processor configured to execute additional instructions to further cause the controller to:
receive user input from the input device; and
activate a user selected device from one of the attached devices and disable the controller from deactivating the one user selected device.

11. A method for providing a solar powered energy source limiting power consumption of attached devices, the solar powered energy source comprises one or more power cells for providing electrical power to the attached devices, a rechargeable battery, and a controller, the controller comprises a voltage regulator-charger for connecting the rechargeable battery and the one or more power cells to the attached devices, and a plurality of device power consumption regulators for controlling outgoing electrical power provided by the controller to each of the attached devices, the method comprising:
detecting a battery charge level in the rechargeable battery;
determining power output currently generated by the one or more power cells;
determine whether total power consumption of the attached devices is greater than an available power limit; and
when the total power consumption of the attached devices is greater than the available power limit, performing the following steps until the total power consumption of the attached devices is greater than the available power limit:
determining a lowest priority attached device currently active; and
deactivating lowest priority attached device currently active;
wherein the available power limit is defined to permit any active attached device to operate for a user specified time period at the current power consumption at which time the rechargeable battery will be empty.

12. The method according to claim 11, where the method further comprising:
when one or more of the power cells are active, activating the power cells to provide electrical power to the voltage-regulator-charger; and
when the rechargeable battery is fully charged, disconnecting the active one or more power cells from the battery.

13. The method according to claim 12, where the controller further comprises:
a user interface connecting the controller to a user display device and a user input device for receiving user input; and
the method further comprising:
receiving user input from the input device; and
activating, a user selected device from one of the attached devices and disable the controller from deactivating the one user selected device.

14. The method according to claim 11, wherein the one or more power cells comprise:
one or more solar cells; and
one or more thermo-radiative power cells.

15. The method according to claim 11, wherein the user display device and the user input device comprise a touch screen display.
